(19) United States
(12) Patent Application Publication
(10) Pub. No.: US 2013/0221053 A1
(43) Pub. Date: Aug. 29, 2013

(54) METHOD AND APPARATUS FOR SEPARATION OF STRENGTHENED GLASS AND ARTICLES PRODUCED THEREBY

(71) Applicant: ELECTRO SCIENTIFIC INDUSTRIES, INC., (US)

(72) Inventor: Haibin ZHANG, Portland, OR (US)

(73) Assignee: ELECTRO SCIENTIFIC INDUSTRIES, INC., Portland, OR (US)

(21) Appl. No.: 13/779,050

(22) Filed: Feb. 27, 2013

Related U.S. Application Data
(60) Provisional application No. 61/604,416, filed on Feb. 28, 2012.

(51) Int. Cl. C03B 33/02; C03B 33/10

(52) U.S. Cl. CPC C03B 33/0222; C03B 33/102
USPC 225/2; 225/96; 428/410

(57) ABSTRACT

Methods and apparatus for separating substrates are disclosed, as are articles formed from the separated substrates. A method of separating a substrate having a main surface, a tension region within an interior thereof, and a compression region between the main surface and the tension region, includes forming a modified stress zone extending along a guide path within the substrate such that a first portion of the substrate is within the modified stress zone, wherein the portion of the substrate within the modified stress zone has a modified stress different from a preliminary stress of the first portion. A vent crack also formed in the first main surface. The vent crack and the modified stress zone are configured to separate the substrate along the guide path.

### CROSS-REFERENCE TO RELATED APPLICATIONS

This application claims the benefit of U.S. Provisional Application No. 61/604,416, filed Feb. 28, 2012, which is hereby incorporated by reference in its entirety.

### BACKGROUND

Embodiments of the present invention relate generally to methods for separating substrates of glass and, more specifically, to methods for separating strengthened glass substrates. Embodiments of the present invention also relate to apparatuses for separating substrates of glass, and to pieces of glass that have been separated from substrates of glass.

Thin strengthened glass substrates, such as chemically- or thermally-strengthened substrates have found wide-spread application in consumer electronics because of their excellent strength and damage resistance. For example, such glass substrates may be used as cover substrates for LCD and LED displays and touch applications incorporated in mobile telephones, display devices such as televisions and computer monitors, and various other electronic devices. To reduce manufacturing costs, it may be desirable that such glass substrates used in consumer electronics devices be formed by performing thin film patterning for multiple devices on a single large glass substrate, then sectioning or separating the large glass substrate into a plurality of smaller glass substrates using various cutting techniques.

However the magnitude of compressive stress and the elastic energy stored within the central tension region may make cutting and finishing of chemically- or thermally-strengthened glass substrates difficult. The high surface compression and deep compression layers make it difficult to mechanically scribe the glass substrate as in traditional scribe-and-bend processes. Furthermore, if the stored elastic energy in the central tension region is sufficiently high, the glass may break in an explosive manner when the surface compression layer is penetrated. In other instances, the release of the elastic energy may cause the break to deviate from a desired guide path. Accordingly, a need exists for alternative methods for separating strengthened glass substrates.

### SUMMARY

One embodiment described herein can be exemplarily characterized as a method that includes: providing a substrate having a first main surface, a tension region within an interior of the substrate and a compression region between the first main surface and the tension region, wherein a first portion of the substrate has a preliminary stress; forming a modified stress zone extending along a guide path within the substrate such that the first portion of the substrate is within the modified stress zone, wherein the portion of the substrate within the modified stress zone has a modified stress different from the preliminary stress; and after forming the modified stress zone, forming a vent crack in the first main surface, wherein the vent crack and the modified stress zone are configured such that the substrate is separable along the guide path upon forming the vent crack.

Another embodiment described herein can be exemplarily characterized as a method that includes: providing a substrate having a first main surface, a second main surface opposite the first main surface, an edge surface extending from the first main surface to the second main surface, a tension region within an interior of the substrate and a compression region between the first main surface and the tension region, wherein a portion of the substrate has a preliminary stress; contacting at least the one of the first main surface and the second main surface with a support member configured to support the substrate, wherein a portion of the at least one of the first main surface and the second main surface adjoining the edge surface is spaced apart from the support member; forming a vent crack in the first main surface, wherein the vent crack is aligned with a guide path extending to the edge surface; and after forming the vent crack, forming a modified stress zone extending along the guide path within the substrate such that the portion of the substrate is within the modified stress zone, wherein the portion of the substrate within the modified stress zone has a modified stress different from the preliminary stress, wherein the vent crack and the modified stress zone are configured such that the substrate is separable along the guide path upon forming the modified stress zone.

Yet another embodiment described herein can be exemplarily characterized as an apparatus for separating a substrate having a first main surface, a tension region within an interior of the substrate and a compression region between the first main surface and the tension region, wherein a portion of the substrate has a preliminary stress. The apparatus can include: a stress modification system configured to form a modified stress zone extending along a guide path within the substrate such that the portion of the substrate is within the modified stress zone and has a modified stress different from the preliminary stress; a vent crack initiator system configured to form a vent crack in the first main surface; and a controller coupled to the stress modification system and the vent crack initiator system. The controller can include: a processor configured to execute instructions to control the stress modification system and the vent crack initiator system to: form the modified stress zone extending along the guide path and form the vent crack in the first main surface such that the substrate is separable along the guide path. The controller can also include a memory configured to store the instructions.

Still another embodiment described herein can be exemplarily characterized as an article of manufacture comprising a piece of strengthened glass produced by any method described herein.

### BRIEF DESCRIPTION OF THE DRAWINGS

FIGS. 1A and 1B are top plan and cross-section views, respectively, illustrating a strengthened glass substrate capable of being separated according to embodiments of the present invention.

FIG. 2A is a top plan view illustrating one embodiment of a modified stress zone formed in the substrate exemplarily described with respect to FIGS. 1A and 1B.

FIG. 2B is a cross-section view illustrating one embodiment of forming the modified stress zone shown in FIG. 2A.

FIG. 3 is a graph illustrating an exemplary cross-sectional stress distribution within the substrate, taken along line III-III shown in FIG. 2A.

FIG. 4 is a graph illustrating an exemplary cross-sectional stress distribution within the substrate, taken along line IV-IV shown in FIG. 2A.

FIGS. 5 and 6 are cross-section views illustrating one embodiment of a process of separating a substrate along a modified stress zone as shown in FIG. 2.

FIG. 7 schematically illustrates one embodiment of an apparatus configured to perform the processes exemplarily described with respect to FIGS. 2-6.

### DETAILED DESCRIPTION OF THE ILLUSTRATED EMBODIMENTS

The invention is described more fully hereinafter with reference to the accompanying drawings, in which example embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

In the following description, like reference characters designate like or corresponding parts throughout the several views shown in the figures. As used herein, the singular forms “a,” “an” and “the” are intended to include the plural forms as well, unless the context clearly indicates otherwise. It will also be understood that, unless otherwise specified, terms such as “top,” “bottom,” “outward,” “inward,” and the like, are words of convenience and are not to be construed as limiting terms. In addition, whenever a group is described as “comprising” at least one of a group of elements and combinations thereof, it is understood that the group may comprise, consist essentially of, or consist of any number of those elements recited, either individually or in combination with each other. Similarly, whenever a group is described as “consisting” of at least one of a group of elements or combinations thereof, it is understood that the group may consist of any number of those elements recited, either individually or in combination with each other. Unless otherwise specified, a range of values, when recited, includes both the upper and lower limits of the range, as well as any sub-ranges therebetween.

Referring to the drawings in general, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

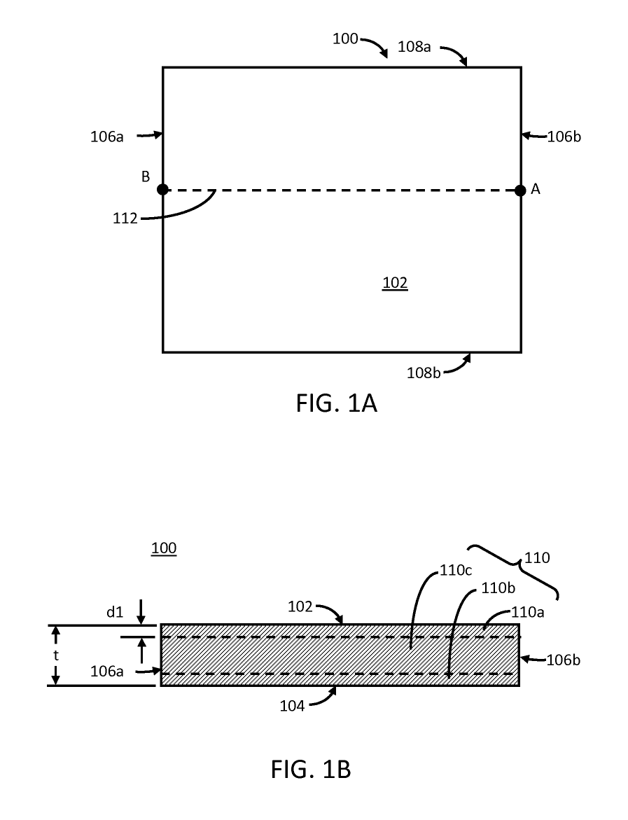

FIGS. 1A and 1B are top plan and cross-section views, respectively, illustrating a strengthened glass substrate capable of being separated according to embodiments of the present invention.

Referring to FIGS. 1A and 1B, a strengthened glass substrate 100 (also referred to herein simply as a “substrate”) includes a first main surface 102, a second main surface 104 opposite the first main surface, and edge surfaces 106a, 106b, 108a and 108b. Generally, the edge surfaces 106a, 106b, 108a and 108b extend from the first main surface 102 to the second main surface 104. Although the substrate 100 is illustrated as essentially square when viewed from a top plan view, it will be appreciated that the substrate 100 can be any shape when viewed from a top plan view. The substrate 100 can be formed from any glass composition including, without limitation, borosilicate glasses, soda-lime glass, aluminosilicate glass, aluminoborosilicate glass, or the like, or a combination thereof. The substrate 100 separated according to the embodiments described herein may be strengthened by a strengthening process such as an ion exchange chemical strengthening process, thermal tempering, or the like or a combination thereof. It should be understood that although embodiments herein are described in the context of chemically strengthened glass substrates, other types of strengthened glass substrates may be separated according the embodiments exemplarily described herein. Generally, the substrate 100 may have a thickness, t, greater than 200 μm and less than 10 mm. In one embodiment, the thickness, t, may be in a range from 500 μm to 2 mm. In another embodiment, the thickness, t, may be in a range from 600 μm to 1 mm. It will be appreciated, however, that the thickness, t, may be greater than 10 mm or less than 200 μm.

Referring to FIG. 1B, an interior 110 of the substrate 100 includes compression regions (e.g., first compression region 110a and second compression region 110b) and a tension region 110c. Portions of the substrate 100 within the compression regions 110a and 110b are kept in a compressive stress state that provides the glass substrate 100 its strength. The portion of the substrate 100 in the tension region 110c is under tensile stress to compensate for the compressive stresses in the compression regions 110a and 110b. Generally, the compressive and tensile forces within the interior 110 balance each other out so the net stress of the substrate 100 is zero.

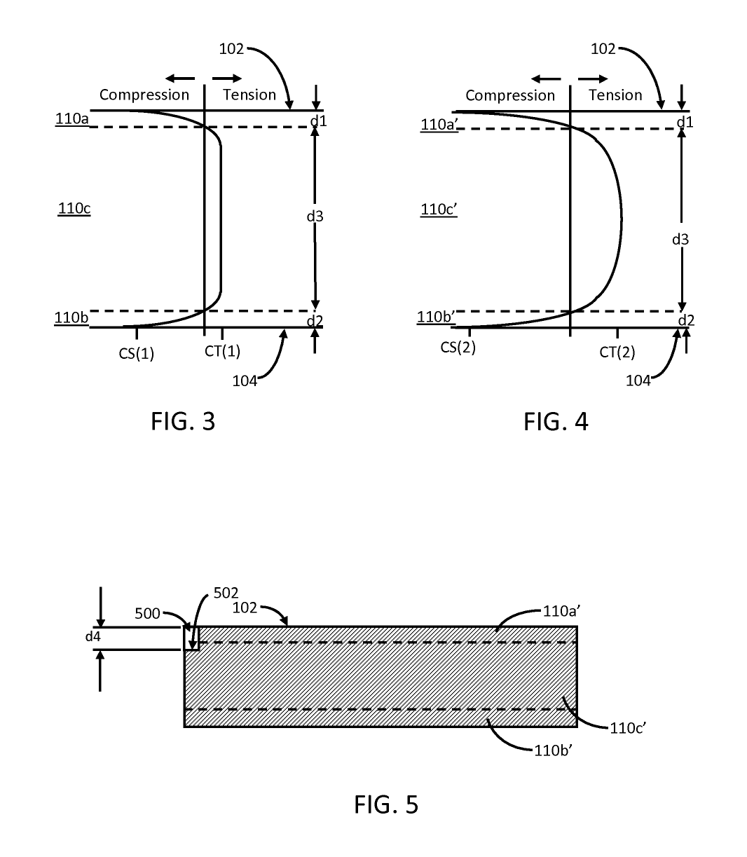

As exemplarily illustrated, the first compression region 110a extends from the first main surface 102 toward the second main surface 104 by a distance (or depth) d1, and thus has a thickness (or “depth of layer”, DOL) of d1. Generally, d1 can be defined as the distance from the physical surface of the substrate 100 to a point within the interior 110 where the stress is zero. The DOL of the second compression region 110b (see, e.g., d2 as denoted in FIGS. 3 and 4) can be equal to d1. The thickness of the tension region 110c (see, e.g., d3 as denoted in FIGS. 3 and 4) can be equal to t−(d1+d2).

Depending on process parameters such as composition of the substrate 100 and the chemical and/or thermal process by which the substrate 100 was strengthened, all of which are known to those skilled in the art, d1 can be generally greater than 10 μm. In one embodiment, d1 is greater than 20 μm. In one embodiment, d1 is greater than 40 μm. In another embodiment, d1 is greater than 50 μm. In yet embodiment, d1 can even be greater than 100 μm. It will be appreciated that the substrate 100 can be prepared in any manner to produce a compression region with d1 less than 10 μm. In the illustrated embodiment, the tension region 110c extends to the edge surfaces 106a and 106b (as well as edge surfaces 108a and 108b). In another embodiment, however, additional compression regions can extend along edge surfaces 106a, 106b, 108a and 108b. Thus, collectively, the compression regions form a compressively-stressed outer region extending from the surfaces of the substrate 100 into an interior of the substrate 100 and the tension region 110c, which is under a state of tension, is surrounded by compressively-stressed outer region.

Depending on the aforementioned process parameters, the magnitude of compressive stress in the compression regions 110a and 110b are measured at or near (i.e., within 100 μm) the first main surface 102 and second main surface 104, respectively, and can be greater than 69 MPa. For example, in some embodiments the magnitude of compressive stresses in the compression regions 110a and 110b can be greater than 100 MPa, greater than 200 MPa, greater than 300 MPa, greater than 400 MPa, greater than 500 MPa, greater than 600 MPa, greater than 700 MPa, greater than 800 MPa, greater than 900 MPa, or even greater than 1 GPa. The magnitude of tensile stress in the tension region 110c can be obtained by the following:

$$CT = \frac{CS \times DOL}{t - 2 \times DOL}$$

where CT is the central tension within the substrate 100, CS is the maximum compressive stress in a compression region(s) expressed in MPa, t is the thickness of the substrate 100 expressed in mm, and DOL is the depth of layer of the compression region(s) expressed in mm.

Having exemplarily described a substrate 100 capable of being separated according to embodiments of the present invention, exemplary embodiments of separating the substrate 100 will now be described. Upon implementing these methods, the substrate 100 can be separated along a guide path such as guide path 112. Although guide path 112 is illustrated as extending in a straight line, it will be appreciated that all or part of the guide path 112 may extend along a curved line. As exemplarily illustrated, the guide path 112 extends to edge surfaces 106a and 106b.

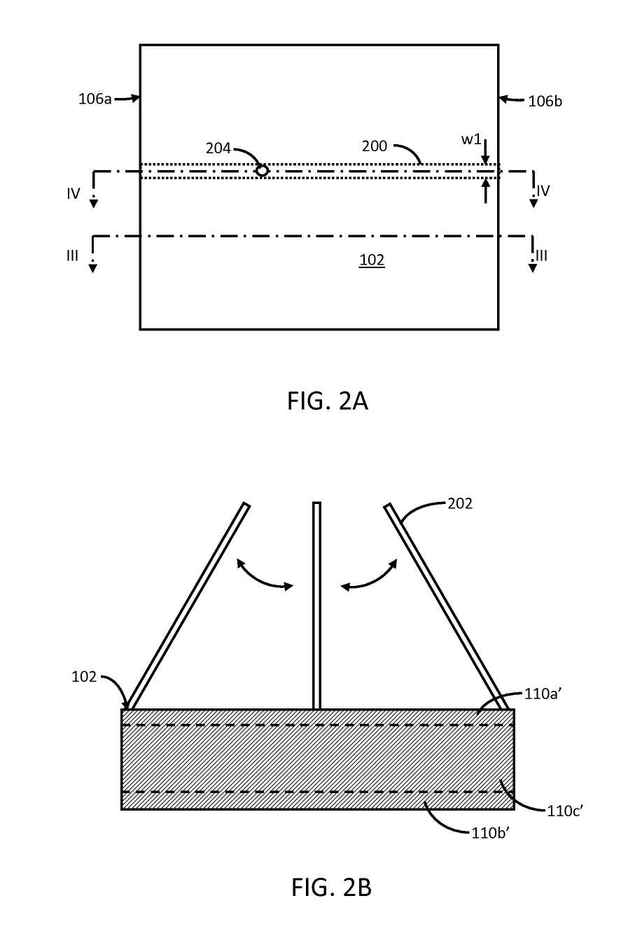

Generally, FIGS. 2A to 6 illustrate one embodiment of a process of separating a strengthened glass substrate such as substrate 100, which includes forming one or more modified stress zones in the substrate 100 and then separating the substrate 100 along the modified stress zone. Generally, a modified stress zone can be formed to extend within the substrate 100 along the guide path 112. A portion of the substrate 100 within the modified stress zone has a stress that is different from a neighboring region of the substrate outside, but adjacent to, the modified stress zone. Thus a portion of the substrate 100 can have a preliminary stress (e.g., a preliminary tensile stress or a preliminary compressive stress) before the modified stress zone is formed. After the modified stress zone is formed, however, the portion of the substrate 100 within the modified stress zone can have a modified stress that is different from the preliminary stress. When the preliminary stress is a tensile stress (i.e., a preliminary tensile stress) the modified stress can also be a tensile stress (i.e., a modified tensile stress) greater in magnitude than the preliminary tensile stress. Likewise, when the preliminary stress is a compressive stress (i.e., a preliminary compressive stress) the modified stress can also be a compressive stress (i.e., a modified compressive stress) greater in magnitude than the preliminary compressive stress. After forming the modified stress zone, a vent crack can be formed in a main surface of the substrate 100. As will be discussed in greater detail below, the vent crack and the modified stress zone(s) can be configured such that the substrate 100 is separable along the guide path 112 upon forming the vent crack.

FIG. 2A is a top plan view illustrating one embodiment of a modified stress zone and FIG. 2B is a cross-section view illustrating one embodiment of forming the modified stress zone shown in FIG. 2A. FIG. 3 is a graph illustrating an exemplary cross-sectional stress distribution within the substrate, taken along line III-III shown in FIG. 2A, which is outside the modified stress zone 200. Accordingly, the stress distribution graph shown in FIG. 3 also illustrates the cross-sectional stress distribution within the substrate taken along line IV-IV shown in FIG. 2A before forming the modified stress zone 200. FIG. 4 is a graph illustrating an exemplary cross-sectional stress distribution within the substrate, taken along line IV-IV shown in FIG. 2A after the modified stress zone 200 is formed.

Referring to FIG. 2A, a modified stress zone, such as modified stress zone 200, can be formed so as to extend within the substrate 100 along the guide path 112 shown in FIG. 1A. The modified stress zone 200 can be formed by heating the substrate 100, cooling the substrate 100, applying a bending moment to the substrate 100, or the like or a combination thereof. As shown in FIG. 2A, the modified stress zone can be characterized as having a width, w1. As used herein, w1 is measured along a direction substantially orthogonal to the guide path 112 and the magnitude of w1 corresponds to the distance between regions in the substrate that have a modified stress that is within some threshold of a maximum modified stress within the modified stress zone 200. In some embodiments, the threshold can be at least 5% of the maximum modified stress, at least 10% of the maximum modified stress, at least 20% of the maximum modified stress, at least 30% of the maximum modified stress, at least 40% of the maximum modified stress, at least 50% of the maximum modified stress, at least 60% of the maximum modified stress, or less than 5% of the maximum modified stress. It will be appreciated that w1 can be influenced by the manner in which the substrate 100 is heated, cooled, bent, or the like.

Referring to FIG. 2B, portions of the compression regions 110a and 110b located within the modified stress zone 200 are referred to herein as modified compression regions 110a′ and 110b′, respectively, and a portion of the tension region 110c located within the modified stress zone 200 is referred to herein as a modified tension region 110c′. As shown in FIGS. 3 and 4, forming the modified stress zone 200 results in a modification of stress in the compression regions 110a and 110b from the preliminary compressive stress CS(1) (see FIG. 3) to a modified compressive stress CS(2) (see FIG. 4). Likewise, forming the modified stress zone 200 results in a modification of stress in the tension region 110c from the preliminary tensile stress CT(1) (see FIG. 3) to a modified tensile stress CT(2) (see FIG. 4). Generally, CS(2) is greater than CS(1) and CT(2) is greater than CT(1). In some embodiments, CS(2) can be at least 5% greater than CS(1), at least 10% greater than CS(1), at least 20% greater than CS(1), at least 30% greater than CS(1), at least 40% greater than CS(1), at least 50% greater than CS(1), at least 100% greater than CS(1), less than 5% greater than CS(1) or more than 100% greater than CS(1). Likewise, CT(2) can be at least 5% greater than CT(1), at least 10% greater than CT(1), at least 20% greater than CT(1), at least 30% greater than CT(1), at least 40% greater than CT(1), at least 50% greater than

CT(1), at least 100% greater than CT(1), less than 5% greater than CT(1) or more than 100% greater than CT(1).

When forming the modified stress zone 200 by heating the substrate 100, the substrate 100 may be heated such that the first main surface 102 and/or the second main surface 104 (each generically referred to herein as a “main surface” of the substrate 100) is heated to a temperature that is less than the glass transition temperature of the substrate 100. In some embodiments, a main surface of the substrate is heated to a temperature of at least 70% of the glass transition temperature of the substrate 100, at least 80% of the glass transition temperature of the substrate 100, or at least 90% of the glass transition temperature of the substrate 100. In one embodiment, a main surface of the substrate 100 is heated to a temperature of about 650 degrees C. The substrate 100 may be heated by directing a beam 202 of laser light onto the substrate 100, by positioning a heater (e.g., an incandescent lamp, a ceramic heater, a quartz heater, a quartz tungsten heater, a carbon heater, a gas-fired heater, semiconductor heater, a microheater, a heater core, or the like or a combination thereof) in thermal proximity to the substrate 100, or the like or a combination thereof.

In the illustrated embodiment, one beam 202 of laser light is directed onto the substrate 100. In other embodiments however, more than one beam 202 of laser light may be directed onto the substrate 100. For example, at least two of the beams of laser light may be directed onto the same main surface of the substrate 100, onto different main surfaces of the substrate 100, or a combination thereof. When directing more than one beam of laser light onto the substrate 100, at least two of the beams may be directed onto the substrate 100 at locations that are aligned along a direction perpendicular, oblique or parallel to the guide path 112.

In the illustrated embodiment, the beam 202 of laser light is caused to be scanned relative to the substrate 100 (e.g., between points A and B, illustrated in FIG. 1A) along the guide path 112 at least once. Generally, the beam 202 can be scanned between the two points along a guide path 112 at a scan rate greater than or equal to 1 m/s. In another embodiment, the beam 202 is scanned between the two points along a guide path 112 at a scan rate greater than 2 m/s. It will be appreciated, however, that the beam 202 may also be scanned between the two points along the guide path 112 at a scan rate less than 1 m/s. As illustrated, point A is located at an edge where the first main surface 102 meets the edge surface 106b and point B is located at an edge where the first main surface 102 meets the edge surface 106b. It will be appreciated that one or both of points may be located at a position different from that illustrated. For example, point B can be located at the edge 106a. Depending on, among other factors, the size and shape of a spot 204 on the substrate 100 produced by the beam 202, the beam 202 may be stationary relative to the substrate 100.

Generally, the beam 202 of laser light is directed onto the substrate along an optical path so that the beam 202 passes through the first surface 102 and, thereafter, through the second surface 104. Light within the beam 202 of laser light has at least one wavelength suitable for imparting thermal energy to the strengthened glass substrate 100 such that the laser energy is strongly absorbed through the glass thickness h, thereby heating the substrate 100. For example, light within the beam 202 can include infrared light with a wavelength greater than 2 μm. In one embodiment, the beam 202 can be produced by a CO₂ laser source and have a wavelength from about 9.4 μm to about 10.6 μm; or by a CO laser source and have a wavelength from about 5 μm to about 6 μm; or by an HF laser source and have a wavelength from about 2.6 μm to about 3.0 μm; or by an erbium YAG laser and have a wavelength of about 2.9 μm. In one embodiment, the laser source producing the beam 202 may be a DC current laser source operated in a continuous wave mode. In another embodiment, the laser source producing the beam 202 may be provided as an RF-excited laser source, capable of operating in a pulsed mode within a range of about 5 kHz to about 200 kHz. The power at which any laser source is operated can depend on the thickness of the substrate 100, the surface area of the substrate 100, and the like. Depending on the wavelength of light within the beam 202, the laser source may be operated at a power within a range of several tens of watts to several hundreds or thousands watts.

Generally, parameters of the beam 202 (also referred to herein as “beam parameters”) such as the aforementioned wavelength, pulse duration, repetition rate and power, in addition to other parameters such as spot size, spot intensity, fluence, or the like or a combination thereof, can be selected such that the beam 202 has an intensity and fluence in a spot 204 at the first main surface 102 that is sufficient to avoid undesirable overheating of the substrate 100 (which may cause ablation or vaporization of the substrate 100 at the first main surface 102). In one embodiment, the spot 204 can have an elliptical shape with a major diameter of about 50 mm and a minor diameter of about 5 mm. It will be appreciated, however, that the spot 204 can have any size and can be provided in any shape (e.g., circle, line, square, trapezoid, or the like or a combination thereof).

Modified stress zone parameters such as the width w1, the maximum modified stress within the modified stress zone, location of maximum modified stress along the thickness direction of the substrate 100, and the like, can be selected by adjusting one or more heating parameters, cooling parameters, bending parameters and/or the aforementioned beam parameters. Exemplary heating parameters include the temperature to which the substrate 100 is heated, the area of the substrate 100 that is heated, the use of any cooling mechanisms in conjunction with the heating, or the like or a combination thereof.

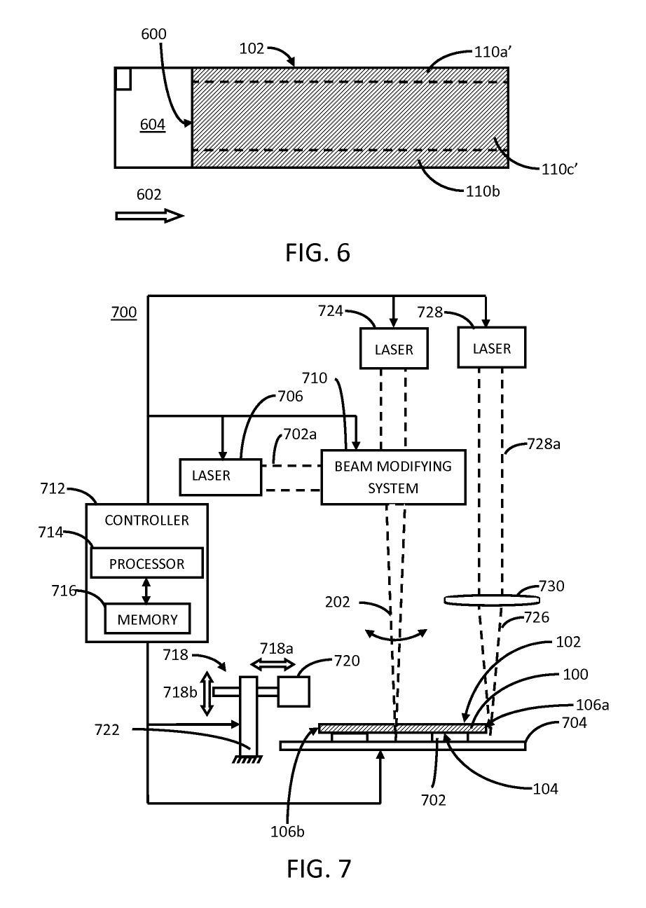

FIGS. 5 and 6 are cross-section views illustrating one embodiment of a process of separating a substrate along a modified stress zone as shown in FIG. 2.

In one embodiment, the aforementioned modified stress zone parameters can be selected to ensure that the substrate 100 is prevented from spontaneously separating along the modified stress zone 200. In such an embodiment, one or more additional processes can be performed to form a vent crack within the substrate 100 after the modified stress zone 200 is formed. The width, depth, size, etc., of such a vent crack can be selected and/or adjusted (e.g., based on the parameters of the one or more additional processes) to ensure that the substrate 100 can be separated along the guide path 112 upon forming the vent crack. Thus, the vent crack and the modified stress zone 200 can be configured such that the substrate 100 is separable along the guide path 112 upon forming the vent crack. The vent crack can be formed in any manner. For example, the vent crack can be formed by laser radiation onto the substrate 100, by mechanically impacting the substrate 100, by chemically etching the substrate 100, by cooling the substrate 100, or the like or a combination thereof.

When forming the vent crack by directing laser radiation onto the substrate 100, the laser radiation can have at least one wavelength that is greater than 100 nm. In one embodiment, the laser radiation can have at least one wavelength that is less than 11 μm. For example, the laser radiation can have at least one wavelength that is less than 3000 nm. In another embodiment, the laser radiation has at least one wavelength selected from the group consisting of 266 nm, 523 nm, 532 nm, 543 nm, 780 nm, 800 nm, 1064 nm, 1550 nm, 10.6 μm, or the like. In one embodiment, the laser radiation can be directed into the modified stress zone 200, outside the modified stress zone 200, or a combination thereof. Similarly, the laser radiation can be directed at an edge of a main surface of the substrate 100 or away from the edge of the main surface. In one embodiment, the laser radiation can have a beam waist located outside the substrate 100 or at least partially coincident with any portion of the substrate 100. In another embodiment, the laser radiation used to form the vent crack can be provided as exemplarily described in U.S. Provisional App. No. 61/604,380, entitled “METHOD AND APPARATUS FOR SEPARATION OF STRENGTHENED GLASS AND ARTICLES PRODUCED THEREBY” (Attorney Docket No. E129:P1), filed Feb. 28, 2012, the contents of which are incorporated herein by reference. When forming the vent crack by mechanically impacting the substrate 100, a portion of the substrate 100 can be removed by any suitable method (e.g., by hitting, grinding, cutting, or the like or a combination thereof). When forming the vent crack by chemically etching the substrate 100, a portion of the substrate 100 can be removed upon being contacted with an etchant (e.g., a dry etchant, a wet etchant, or the like or a combination thereof). When forming the vent crack by cooling the substrate 100, a portion of the substrate 100 can be contacted with a heat sink (e.g., a nozzle operative to eject a coolant onto the substrate, or the like or a combination thereof).

In other embodiments, the vent crack can be characterized as being formed by removing a portion of the substrate 100. With reference to FIG. 5, the vent crack according to one embodiment can be formed by removing a portion of the substrate 100 to form an initiation trench, such as initiation trench 500, along the guide path 112. Thus, the initiation trench 500 can be aligned with the modified stress zone 200. In another embodiment, however, the initiation trench 500 can be spaced apart from the guide path 112 so as not to be aligned with the modified stress zone 200. In such an embodiment, the initiation trench 500 is still sufficiently close to the guide path 112 to initiate a crack that can propagate to the modified stress zone 200. The width of the initiation trench 500 can be greater than, less than or equal to the width, w1, of the of the modified stress zone 200. As exemplarily illustrated, the length of the initiation trench 500 (e.g., as measured along the guide path 112 shown in FIG. 1A) is less than the length of the modified stress zone 200 (e.g., as also measured along the guide path 112). In other embodiments, however, the length of the initiation trench 500 can be equal to or greater than the length of the modified stress zone 200.

As exemplarily illustrated, the initiation trench 500 extends to a depth d4 such that a lower surface 502 extends into the modified tension region 110c′. In another embodiment, however, the initiation trench 500 can extend almost to the modified tension region 110c′ or extend to a boundary between modified compression region 110a′ and the modified tension region 110c′. Similar to the depth dl, the depth d4 of the initiation trench 500 can be defined as the distance from the physical surface of the substrate 100 in which it is formed (e.g., the first main surface 102, as exemplarily illustrated) to the lower surface 502 of the initiation trench 500. When greater than d1, d4 can be in a range of 5% (or less than 5%) to 100% (or more than 100%) greater than d1. When less than d1, d4 can be in a range of 1% (or less than 1%) to 90% (or more than 90%) less than d1. In one embodiment, the aforementioned beam parameters, scanning parameters, beam waist placement parameters, or the like, or a combination thereof can be selected such that d4 can be at least 20 μm, at least 30 μm, at least 40 μm, at least 50 μm, greater than 50 μm, less than 20 μm, or the like. In another embodiment, d4 can be about 40 μm or about 50 μm. The initiation trench 500 can be formed by any desired method. For example, the initiation trench 500 can be formed by directing laser radiation onto the substrate 100, by mechanically impacting the substrate 100 (e.g., by cutting, grinding, etc.), by chemically etching the substrate 100, or the like or a combination thereof.

Upon forming the vent crack, the vent crack spontaneously propagates along the modified stress zone 200 to separate the substrate 100 along the guide path 112. For example, and with reference to FIG. 6, a leading edge 600 of the vent crack can propagate in the direction indicated by arrow 602, along the modified stress zone 200. Reference numeral 604 identifies a new edge surface of a portion of the substrate 100 that has been separated along the guide path 112. After the crack 600 propagates along the length of modified stress zone 200, the substrate 100 is fully separated into strengthened glass articles (also referred to herein as “articles”). Because the substrate 100 was heated to a point below the glass transition temperature thereof, there is no surface damage in the articles produced. Accordingly, the strength of the articles can be at least substantially maintained.

Although the process discussed above describes forming the vent crack after forming the modified stress zone 200, it will be appreciated that the process can be reversed: the modified stress zone 200 can be formed after forming the vent crack. In such an embodiment, the vent crack can be formed such that the substrate 100 is prevented from spontaneously separating until after the modified stress zone 200 is formed.

Strengthened glass articles produced by the processes exemplarily described herein can be used as protective cover plates (as used herein, the term “cover plate” includes a window, or the like) for display and touch screen applications such as, but not limited to, portable communication and entertainment devices such as telephones, music players, video players, or the like; and as a display screen for information-related terminals (IT) (e.g., portable computer, laptop computer, etc.) devices; as well as in other applications. It will be appreciated that the articles exemplarily described above may be formed using any desired apparatus. FIG. 7 schematically illustrates one embodiment of an apparatus configured to perform the processes exemplarily described with respect to FIGS. 2-6.

Referring to FIG. 7, an apparatus, such as apparatus 700, can separate a strengthened glass substrate such as substrate 100. The apparatus 700 may include a workpiece positioning system and a stress modification system.

Generally, the workpiece support system is configured to support the substrate 100 such that the first surface 102 faces toward the stress modification system and such that a laser beam 202 produced by the stress modification system can be directed onto the substrate 100 as exemplarily described above with respect to FIG. 2B. As exemplarily illustrated, the workpiece support system can include a support member such as chuck 702 configured to support the substrate 100 and a movable stage 704 configured to move the chuck 702. It has been discovered by the inventors that the closeness with which the crack 600 follows the guide path 112 can sometimes be improved when the edge surfaces to which the guide path 112 extends away from the chuck 702 (i.e., when portions of the second main surface 104 adjoining the edge surfaces 106a and 106b are spaced apart from the chuck 702). Thus, the chuck 702 can be configured to contact only a portion of the second main surface 104 of substrate 100 (e.g., as illustrated). For example, the chuck 702 can support the substrate 100 such that portions of the first main surface 102 and the second main surface 104 that adjoin the edge surfaces 106a and 106b (i.e., the edge surfaces to which the guide path extends) are spaced apart from the chuck 702. Nevertheless in other embodiments, the chuck 702 may contact an entirety of the second main surface 104. Generally, the moveable stage 704 is configured to move the chuck 702 laterally relative to the stress modification system. Thus the moveable stage 704 can be operated to cause a spot (e.g., aforementioned spot 204) on the substrate 100 produced by the laser beam 202 to be scanned relative to the substrate 100.

In the illustrated embodiment, the stress modification system includes a laser system configured to direct the beam 202 of laser light along an optical path. As exemplarily illustrated, the laser system may include a laser 706 configured to produce a beam 702a of laser light and an optional optical assembly 708 configured to focus the beam 702a to produce a beam waist (which can be positioned outside the substrate 100). The optical assembly 708 may include a lens and may be moveable along a direction indicated by arrow 708a to change the location (e.g., along a z-axis) of the beam waist of the beam 202 relative to the substrate 100. The laser system may further include a beam modifying system 710 configured to move the beam waist of the beam 202 laterally relative to the substrate 100 and the workpiece support system. In one embodiment, the beam modifying system 710 can include a galvanometer, a fast steering mirror, an acousto-optic deflector, an electro-optic deflector, a polygon scanning mirror or the like or a combination thereof. Thus the beam modifying system 710 can be operated to cause the beam 202 to be scanned relative to the substrate 100 as discussed above with respect to FIG. 2B. Additionally or alternatively, the beam modifying system 710 can include one or more lenses configured to shape the beam 702a into a line-shaped beam, an elliptical-shaped beam, or the like or a combination thereof.

Although the stress modification system has been described above as including the aforementioned laser system, it will be appreciated that the stress modification system can include other components as an addition or an alternative to the laser system. For example, the stress modification system can include a biasing member (not shown) operative to press against the substrate 100 to create a bending moment within the substrate 100. The biasing member can, for example, include a bar, a beam, a pin, or the like or a combination thereof. In another example, the stress modification system can include a heat source operative to heat a portion of the substrate 100. The heat source can, for example, include an incandescent lamp, a ceramic heater, a quartz heater, a quartz tungsten heater, a carbon heater, a gas-fired heater, semiconductor heater, a microheater, a heater core or the like or a combination thereof.

The apparatus 700 may further include a controller 712 communicatively coupled to one or more of the components of the stress modification system, to one or more of the components of the workpiece support system, or a combination thereof. The controller may include a processor 714 and a memory 716. The processor 714 may be configured to execute instructions stored by the memory 716 to control an operation of at least one component of the stress modification system, the workpiece support system, or a combination thereof so that the embodiments exemplarily described above with respect to FIGS. 1 to 6 can be performed.

Generally, the processor 714 can include operating logic (not shown) that defines various control functions, and may be in the form of dedicated hardware, such as a hardwired state machine, a processor executing programming instructions, and/or a different form as would occur to those skilled in the art. Operating logic may include digital circuitry, analog circuitry, software, or a hybrid combination of any of these types. In one embodiment, processor 714 includes a programmable microcontroller microprocessor, or other processor that can include one or more processing units arranged to execute instructions stored in memory 716 in accordance with the operating logic. Memory 716 can include one or more types including semiconductor, magnetic, and/or optical varieties, and/or may be of a volatile and/or nonvolatile variety. In one embodiment, memory 716 stores instructions that can be executed by the operating logic. Alternatively or additionally, memory 716 may store data that is manipulated by the operating logic. In one arrangement, operating logic and memory are included in a controller/processor form of operating logic that manages and controls operational aspects of any component of the apparatus 700, although in other arrangements they may be separate.

In one embodiment, the controller 712 may control an operation of one or both the stress modification system and the workpiece positioning system to form the initiation trench 500 using the laser 706. In another embodiment, the controller 712 may control an operation of at least one of the stress modification system, the workpiece positioning system and a vent crack initiator system to form the initiation trench 500.

In one embodiment, a vent crack initiator system such as vent crack initiator system 718 may be included within the apparatus 700. The vent crack initiator system 718 can include a vent crack initiator device 720 operative to form the aforementioned initiation trench 400. The vent crack vent crack initiator device 720 may be coupled to a positioning assembly 722 (e.g., a dual-axis robot) configured to move the vent crack initiator device 720 (e.g., along a direction indicated by one or both of arrows 718a and 718b). The vent crack initiator device 720 may include a grinding wheel, a cutting blade, a laser source, an etchant nozzle, a heat sink, or the like or a combination thereof. In one embodiment, the heat sink may be provided as a passive-type heat sink (e.g., that cools the substrate 100 by dissipating heat into the air) or as an active-type heat sink (e.g., that is operative to eject a liquid and/or gaseous coolant such from an outlet or nozzle onto the substrate 100). Exemplary liquids and gases that can be ejected onto the substrate 100 include air, helium, nitrogen, or the like or a combination thereof. A vent crack can be formed by using the heat sink to cool the substrate 100 at a region where a defect has already been formed. Such a defect can, be formed in any manner and, in one embodiment, can be formed using a cutting blade.

In another embodiment, another vent crack initiator system may include a laser, such as laser 724, operative to generate a beam of light and direct the beam of light into the aforementioned laser system to facilitate formation of the initiation trench 500. In yet another embodiment, another vent crack initiator system may include a supplemental laser system configured to generate a beam 726 of laser light sufficient to form the initiation trench 500 as exemplarily described above. Accordingly, the supplemental laser system can include a laser 728 operative to generate a beam 728a of light an optical assembly 730 (e.g., a lens) configured to focus the beam 728a direct the focused beam 726 to the substrate 100.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method, comprising:
providing a substrate having a first main surface, a tension region within an interior of the substrate and a compression region between the first main surface and the tension region, wherein a first portion of the substrate has a preliminary stress;
forming a modified stress zone extending along a guide path within the substrate such that the first portion of the substrate is within the modified stress zone, wherein the portion of the substrate within the modified stress zone has a modified stress different from the preliminary stress; and
after forming the modified stress zone, forming a vent crack in the first main surface,
wherein the vent crack and the modified stress zone are configured such that the substrate is separable along the guide path upon forming the vent crack.

2. The method of claim 1, wherein the portion of the substrate is arranged within the tension region.

3. The method of claim 1, wherein the portion of the substrate is arranged within the compression region.

4. The method of claim 1, wherein the preliminary stress is a tensile stress.

5. The method of claim 4, wherein the modified stress is a tensile stress having a magnitude greater than the preliminary tensile stress.

6. The method of claim 1, wherein the substrate comprises a second main surface opposite the first main surface and an edge surface extending from the first main surface to the second main surface, wherein the guide path extends to the edge surface and wherein forming the vent crack comprises:
contacting at least one of the first main surface and the second main surface with a support member configured to support the substrate, wherein a portion of the at least one of the first main surface and the second main surface adjoining the edge surface is spaced apart from the support member; and
forming the vent crack within the substrate supported by the support member.

7. The method of claim 1, wherein the substrate is a strengthened glass substrate.

8. The method of claim 1, wherein the substrate has a thickness greater than 200 μm.

9. The method of claim 1, wherein the strengthened glass substrate has a thickness less than 10 mm.

10. The method of claim 1, wherein forming the modified stress zone comprises heating the substrate.

11. The method of claim 10, wherein the substrate is a strength glass substrate and wherein heating the substrate comprises heating the first main surface of the substrate to a temperature less than a glass transition temperature of the substrate.

12. The method of claim 10, wherein the substrate is a strength glass substrate and wherein heating the substrate comprises heating a second main surface of the substrate opposite the first main surface to a temperature less than a glass transition temperature of the substrate.

13. The method of claim 10, wherein the substrate is a strength glass substrate and wherein heating the substrate comprises heating the substrate to a temperature more than 70% of the glass transition temperature of the substrate.

14. The method of claim 10, wherein heating the substrate comprises directing at least one beam of laser light onto the substrate.

15. The method of claim 14, wherein directing the at least one beam of laser light onto the substrate comprises scanning the at least one beam of laser light along the guide path.

16. The method of claim 1, wherein at least a portion of the guide path extends in a straight line.

17. The method of claim 1, wherein at least a portion of the guide path extends in a curved line.

18. The method of claim 1, wherein forming the vent crack comprises at least one selected from the group consisting of directing a laser radiation onto the substrate, mechanically impacting the substrate, and cooling the substrate.

19. A method, comprising:
providing a substrate having a first main surface, a second main surface opposite the first main surface, an edge surface extending from the first main surface to the second main surface, a tension region within an interior of the substrate and a compression region between the first main surface and the tension region, wherein a portion of the substrate has a preliminary stress;
contacting at least the one of the first main surface and the second main surface with a support member configured to support the substrate, wherein a portion of the at least one of the first main surface and the second main surface adjoining the edge surface is spaced apart from the support member;
forming a vent crack in the first main surface, wherein the vent crack is aligned with a guide path extending to the edge surface; and
after forming the vent crack, forming a modified stress zone extending along the guide path within the substrate such that the portion of the substrate is within the modified stress zone, wherein the portion of the substrate within the modified stress zone has a modified stress different from the preliminary stress,
wherein the vent crack and the modified stress zone are configured such that the substrate is separable along the guide path upon forming the modified stress zone.

20. An apparatus for separating a substrate having a first main surface, a tension region within an interior of the substrate and a compression region between the first main surface and the tension region, wherein a portion of the substrate has a preliminary stress, the apparatus comprising:
a stress modification system configured to form a modified stress zone extending along a guide path within the substrate such that the portion of the substrate is within the modified stress zone and has a modified stress different from the preliminary stress;
a vent crack initiator system configured to form a vent crack in the first main surface; and
a controller coupled to the stress modification system and the vent crack initiator system, the controller comprising:
a processor configured to execute instructions to control the stress modification system and the vent crack initiator system to:
form the modified stress zone extending along the guide path and form the vent crack in the first main surface such that the substrate is separable along the guide path; and
a memory configured to store the instructions.

21. The apparatus of claim 20, wherein the substrate further has a second main surface opposite the first main surface and an edge surface extending from the first main surface to the second main surface, wherein the apparatus further comprises:
a workpiece support system configured to support the substrate, wherein the workpiece support system comprises a support member configured to contact at least one of the first main surface and the second main surface such that a portion of the at least one of the first main surface and the second main surface adjoining the edge surface is spaced apart from the support member.

22. An article of manufacture comprising a piece of strengthened glass produced by separating a glass substrate according to the method of claim 1.
